(19) United States
(12) Patent Application Publication
(10) Pub. No.: US 2023/0233966 A1
(43) Pub. Date: Jul. 27, 2023

(54) ELECTRET FIBER SHEET, LAMINATE SHEET, AND FILTER

(71) Applicant: Toray Industries, Inc., Tokyo (JP)

(72) Inventors: Rika Kameshima, Otsu-shi, Shiga (JP); Sachio Inaba, Otsu-shi, Shiga (JP); Shingo Hayashi, Otsu-shi, Shiga (JP)

(73) Assignee: Toray Industries, Inc., Tokyo (JP)

(21) Appl. No.: 18/010,926

(22) PCT Filed: Jun. 22, 2021
(86) PCT No.: PCT/JP2021/023537

§ 371 Date: Dec. 16, 2022

(30) Foreign Application Priority Data
Jun. 30, 2020 (JP) 2020-112491

(51) Int. Cl. B01D 39/16; B03C 3/28; D04H 3/007; D04H 3/16

(52) U.S. Cl. CPC B01D 39/1623; B03C 3/28; D04H 3/007; D04H 3/16; B01D 2239/0435; B01D 2239/0622; B01D 2239/1233

(57) ABSTRACT

The purpose of the present invention is to provide an electret fiber sheet that has high collection performance and that is suitably used in an air filter, etc. The present invention is an electret fiber sheet configured from polyolefin-based resin fibers comprising a polyolefin-based resin composition containing a high-crystalline polyolefin resin and a low-crystalline polyolefin resin, wherein the mass ratio of the low-crystalline polyolefin resin in the polyolefin-based resin composition is 0.5-10 mass % (inclusive) relative to the total mass of the high-crystalline polyolefin-based resin and the low-crystalline polyolefin resin, and a hindered-amine-based compound is included in the electret fiber sheet in an amount of 0.1-5.0 mass % (inclusive).

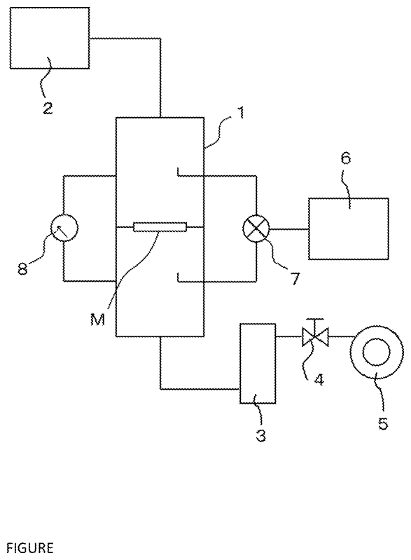

### CROSS REFERENCE TO RELATED APPLICATIONS

This is the U.S. National Phase application of PCT/JP2021/023537, filed Jun. 22, 2021 which claims priority to Japanese Patent Application No. 2020-112491, filed Jun. 30, 2020, the disclosures of each of these applications being incorporated herein by reference in their entireties for all purposes.

### FIELD OF THE INVENTION

The present invention relates to an electret fiber sheet. More specifically, the present invention relates to an electret fiber sheet excellent in dust collection performance, and a stacked sheet and a filter containing the electret fiber sheet.

### BACKGROUND OF THE INVENTION

Air filters have conventionally been used to remove pollen, dust, and the like in gases, and nonwoven fabrics have often been used as filter media for the air filters.

In a typical filter using a nonwoven fabric, it is difficult to reduce pressure loss while increasing dust collection efficiency. Thus, attempts have been made to obtain a nonwoven fabric suitable for use as a component of a filter by processing a nonwoven fabric into an electret to form an electret fiber sheet and using an electrostatic action in addition to a physical action.

For example, there has been proposed a method for producing an electret nonwoven fabric including continuously processing a nonwoven fabric into an electret fiber sheet by applying a high pressure with a non-contact application electrode while moving a ground electrode and the nonwoven fabric together in a state where the nonwoven fabric is in contact with the ground electrode (see Patent Document 1). A so-called hydrocharge method has also been proposed as a method for charging fibers by contacting them with water, such as a method of spraying water jet streams or water droplet streams to a nonwoven fabric at a pressure sufficient for water to penetrate inside the nonwoven fabric to form an electret fiber sheet, and uniformly mixing positive and negative charges, (see Patent Document 2), or a method of passing a nonwoven fabric on a slit-shaped nozzle and sucking water with the nozzle to allow water to permeate the fiber sheet, and uniformly mixing positive and negative charges (see Patent Document 3).

In addition to the above, there has also been proposed a heat-resistant electret material. The heat-resistant electret material includes a nonwoven fabric including fibers that contain a high molecular weight polymer and at least one stabilizer selected from hindered amine-based, nitrogen-containing hindered phenol-based, metal salt hindered phenol-based, and phenol-based stabilizers blended in the high molecular weight polymer, wherein the electret material has an amount of trapped electric charge as determined from the thermally stimulated depolarization current at a temperature of 100° C. or more of 2.0×10⁻¹⁰ coulombs/cm² or more (see Patent Document 4).

### PATENT DOCUMENTS

Patent Document 1: Japanese Patent Laid-open Publication No. S61-289177
Patent Document 2: U.S. Pat. No. 6,119,691
Patent Document 3: Japanese Patent Laid-open Publication No. 2003-3367
Patent Document 4: Japanese Patent Laid-open Publication No. S63-280408

### SUMMARY OF THE INVENTION

As proposed in Patent Documents 1 to 4, the dust collection performance can be improved to some extent by forming a nonwoven fabric into an electret fiber sheet, but for example, when the nonwoven fabric is used as a filter, further improvement of the dust collection performance is required.

An object of the present invention is to provide an electret fiber sheet having higher dust collection performance in view of the problems of the conventional electret technology and focusing on the above problems.

As a result of intensive studies, the inventors of the present invention have found that an amorphous region in a fiber composed of a polyolefin-based resin having certain crystallinity expands when a specific amount of a low crystalline polyolefin resin is added to the fiber to reduce the crystallinity of the polyolefin-based resin. The inventors of the present invention have also found that simply adding a specific amount of a low crystalline polyolefin resin does not provide sufficient thermal stability in use of the fiber as a filter. The inventors of the present invention have conducted further studies and found that an electret fiber sheet obtained by mixing a specific amount of a hindered amine-based compound in addition to these polyolefin-based resins is excellent in electret thermal stability at a high temperature as well as having significantly improved dust collection performance.

The present invention has been completed based on these findings. The present invention provides the following embodiments of the present invention.

An electret fiber sheet according to embodiments of the present invention is an electret fiber sheet including a polyolefin-based resin fiber composed of a polyolefin-based resin composition containing a high crystalline polyolefin resin and a low crystalline polyolefin resin, wherein the low crystalline polyolefin resin in the polyolefin-based resin composition has a proportion of mass of 0.5 mass % or more and 10 mass % or less with respect to a total mass of the high crystalline polyolefin-based resin and the low crystalline polyolefin resin, and the electret fiber sheet contains a hindered amine-based compound in an amount of 0.1 mass % or more and 5.0 mass % or less.

According to a preferred aspect of the electret fiber sheet of the present invention, the electret fiber sheet has a QF value of 0.12 Pa⁻¹ or more.

According to a preferred aspect of the electret fiber sheet of the present invention, the electret fiber sheet has an average single fiber diameter of 0.1 μm or more and 8.0 μm or less.

According to another aspect of the electret fiber sheet of the present invention, the electret fiber sheet is an electret fiber sheet including a polyolefin-based resin fiber, wherein the electret fiber sheet has a meso pentad fraction of 85 mol % or more and 95 mol % or less, and the electret fiber sheet contains a hindered amine-based compound in an amount of 0.1 mass % or more and 5.0 mass % or less.

A stacked sheet according to embodiments of the present invention includes at least one layer of the electret fiber sheet of the present invention.

A filter according to embodiments of the present invention includes the electret fiber sheet of the present invention.

According to the present invention, since the electret fiber sheet contains a specific amount of a low crystalline polyolefin resin in a high crystalline polyolefin-based resin and contains a specific amount of a hindered amine-based compound, it is possible to obtain an electret fiber sheet, a stacked sheet, and a filter having higher dust collection performance and higher thermal stability than ever before.

### BRIEF DESCRIPTION OF THE DRAWING

The FIGURE is a schematic side view illustrating a device for measuring dust collection efficiency and pressure loss.

### DETAILED DESCRIPTION OF EMBODIMENTS OF THE INVENTION

An electret fiber sheet according to embodiments of the present invention is an electret fiber sheet including a polyolefin-based resin fiber composed of a polyolefin-based resin composition containing a high crystalline polyolefin resin and a low crystalline polyolefin resin, wherein the low crystalline polyolefin resin in the polyolefin-based resin composition has a proportion of mass of 0.5 mass % or more and 10 mass % or less with respect to a total mass of the high crystalline polyolefin-based resin and the low crystalline polyolefin resin, and the electret fiber sheet contains a hindered amine-based compound in an amount of 0.1 mass % or more and 5.0 mass % or less. Hereinafter, the components of the electret fiber sheet will be described in detail, but the present invention is not limited to the scope described below at all as long as the gist thereof is not exceeded.

[Polyolefin-Based Resin Fiber]

First, the electret fiber sheet according to embodiments of the present invention includes a polyolefin-based resin fiber composed of a polyolefin-based resin composition containing a high crystalline polyolefin resin and a low crystalline polyolefin resin. Use of fibers composed of a polyolefin-based composition having high volume resistivity and low water absorption as fibers constituting the electret fiber sheet enables the fiber sheet to exhibit a strong charging property and a strong charge retention property when the fiber sheet is processed into an electret, and a high dust collection efficiency can be achieved from these effects.

Examples of the polyolefin-based resin include homopolymers of polyethylene, polypropylene, polybutene, and polymethylpentene. Resins such as copolymers obtained by copolymerizing these homopolymers with different components, and polymer blends of two or more different polymers may also be used. Among them, polypropylene-based resins and polymethylpentene-based resins are preferably used from the viewpoint of charge retention property. In particular, polypropylene-based resins are preferably used from the viewpoint that they can be used at low cost and that they can easily reduce the fiber diameter. The resin referred to as “polypropylene-based resin”, “polyethylene-based resin”, or the like in the present invention means a resin containing 80 mass % or more of a polypropylene homopolymer (polyethylene homopolymer) and a propylene unit (ethylene unit) among resins such as homopolymers of polypropylene (or polyethylene), copolymers with other components, and polymer blends with dissimilar resins. The same applies to other polyolefin-based resins.

As described above, the polyolefin-based resin composition contains a high crystalline polyolefin resin and a low crystalline polyolefin resin. In the present invention, the low crystalline polyolefin resin refers to a resin having a meso pentad fraction (mmmm) of 60 mol % or less, more preferably 30 mol % or more and 60 mol % or less, and the high crystalline polyolefin resin refers to a general-purpose polyolefin having a melting point of 155° C. or more.

The proportion of mass of the low crystalline polyolefin resin in the polyolefin-based resin composition according to embodiments of the present invention is 0.5 mass % or more and 10 mass % or less with respect to the total mass of the high crystalline polyolefin-based resin and the low crystalline polyolefin resin. The dust collection efficiency of the electret fiber sheet can be improved by setting the proportion of mass to 0.5 mass % or more, preferably 1 mass % or more. An electret fiber sheet having low pressure loss and high dust collection efficiency can be obtained by setting the proportion of mass to 10 mass % or less, preferably 5 mass % or less, and more preferably 3 mass % or less.

The mass ratio between the high crystalline polyolefin resin and the low crystalline polyolefin resin in the polyolefin resin composition of the present invention may be analyzed from the electret fiber sheet. For example, there is a method in which the electret fiber sheet is dissolved in a solvent, the obtained extract is subjected to ¹³C-NMR measurement, and the ratio is determined from the meso pentad fraction.

The high crystalline polyolefin resin of the present invention preferably has a melt flow rate (MFR) of 50 g/10 min or more and 2,500 g/10 min or less as measured under the conditions of a temperature of 230° C., a load of 2.16 kg, and a measurement time of 10 minutes based on “8 A method: Mass measurement method” in JIS K7210-1:2014 “Plastics—Determination of the melt mass-flow rate (MFR) and the melt volume-flow rate (MVR) of thermoplastics—Part 1: Standard test methods”. The diameter of the fibers to constitute the electret fiber sheet can be easily reduced by setting the melt flow rate of the high crystalline polyolefin resin to preferably 50 g/10 min or more, more preferably 150 g/10 min or more. The strength of the fiber sheet can be improved by setting the melt flow rate of the high crystalline polyolefin resin to preferably 2,500 g/10 min or less, more preferably 2,000 g/10 min or less.

In the present invention, the low crystalline polyolefin resin is not particularly limited as long as it satisfies the above-described conditions of meso pentad fraction, but is preferably a resin having a melt flow rate (MFR) of 300 g/10 min or more and 3,000 g/10 min or less as measured under the conditions of a temperature of 230° C., a load of 2.16 kg, and a measurement time of 10 minutes based on “8 A method: Mass measurement method” in JIS K7210-1:2014 “Plastics—Determination of the melt mass-flow rate (MFR) and the melt volume-flow rate (MVR) of thermoplastics—Part 1: Standard test methods”. Examples of such a resin include low crystalline polypropylene “L-MODU” (registered trademark) S400 and 5600 manufactured by Idemitsu Kosan Co., Ltd.

Further, additives such as a heat stabilizer, a weathering agent, and a polymerization inhibitor may be added to the polyolefin-based resin fiber in the polyolefin-based resin composition used in embodiments of the present invention as long as the effect of the present invention is not impaired.

The polyolefin-based resin fiber used in the electret fiber sheet of the present invention may be a composite fiber made of the polyolefin-based resin composition, and may take a composite fiber form of, for example, a core-sheath type, an eccentric core-sheath type, a side-by-side type, a split type, a sea-island type, or an alloy type.

The polyolefin-based resin fiber preferably has an average single fiber diameter of 0.1 μm or more and 8.0 μm or less. The strength of the fiber sheet can be improved by setting the average single fiber diameter to preferably 0.1 μm or more, more preferably 0.3 μm or more, and still more preferably 0.5 μm or more. The dust collection efficiency of the electret fiber sheet can be improved by setting the average single fiber diameter to 8.0 μm or less, more preferably 7.0 μm or less, and still more preferably 5.0 μm or less.

For the average single fiber diameter of the polyolefin-based resin fiber used in the electret fiber sheet in the present invention, 15 measurement samples of 3 mm×3 mm were collected from three points in the width direction of the fiber sheet (two points on the side ends and one point in the center) at five points in every 5 cm in the longitudinal direction, that is, 15 points in total, with an adjusted magnification of 3,000 times with a scanning electron microscope (for example, “VHX-D500” manufactured by KEYENCE CORPORATION), and a fiber surface photograph was taken for each of the collected measurement samples, that is, 15 photographs in total were obtained. The single fiber diameters of the fibers of which the fiber diameters (single fiber diameters) are able to be clearly confirmed in the photographs are measured, the average value thereof is rounded off to the second decimal place, and the obtained value is regarded as the average single fiber diameter.

[Hindered Amine-Based Compound]

Next, the electret fiber sheet of the present invention contains a hindered amine-based compound in an amount of 0.1 mass % or more and 5.0 mass % or less in the electret fiber sheet. An electret fiber sheet excellent in charging property and charge retention property when the fiber sheet is processed into an electret can be obtained by containing the hindered amine-based compound in an amount of 0.1 mass % or more, preferably 0.7 mass % or more. The charging property and the charge retention property can be exhibited at a lower cost by containing the hindered amine-based compound in an amount of 5.0 mass % or less, preferably 3.0 mass % or less.

The content of the hindered amine-based compound may be determined, for example, as follows. The fiber sheet is subjected to Soxhlet extraction with a methanol/chloroform mixed solution, thereafter HPLC fractionation of the extract is repeated, and the structure of each fractionated substance is checked by IR measurement, GC measurement, GC/MS measurement, MALDI-MS measurement, ¹H-NMR measurement, and ¹³C-NMR measurement. The sum of the masses of the fractionated substances containing the additives is obtained, the proportion thereof with respect to the entire fiber sheet is determined, and this proportion is regarded as the content of the hindered amine-based compound.

The hindered amine-based compound used in the present invention is a compound having a structural unit represented by the following General Formula (1).

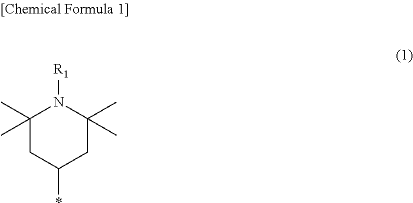

In General Formula (1), R¹ is a hydrogen atom or a methyl group, and * represents a bond.

Examples of the hindered amine-based compound having this structure include poly[(6-(1,1,3,3-tetramethylbutyl)imino-1,3,5-triazine-2,4-diyl) ((2,2,6,6-tetramethyl-4-piperidyl)imino)hexamethylene((2,2,6,6-tetramethyl-4-piperidyl)imino)](“Chimassorb” (registered trademark) 944LD manufactured by BASF Japan Ltd.), a polycondensate of dibutylamine, 1,3,5-triazine, N,N′-bis(2,2,6,6-tetramethyl-4-piperidyl-1,6-hexamethylenediamine, and N-(2,2,6,6-tetramethyl-4-piperidine)butylamine (“Chimassorb” (registered trademark) 2020 manufactured by BASF Japan Ltd.), dimethyl succinate-1-(2-hydroxyethyl)-4-hydroxy-2,2,6,6-tetramethylpiperidine polycondensate (“Tinuvin” (registered trademark) 622LD manufactured by BASF Japan Ltd.), and 2-(3,5-di-t-butyl-4-hydroxybenzyl)-2-n-butylmalonic acid bis(1,2,2,6,6-pentamethyl-4-piperidyl) (“Tinuvin” (registered trademark) 144 manufactured by BASF Japan Ltd.).

Further, the electret fiber sheet of the present invention preferably contains a triazine-based compound in an amount of 0.1 mass % or more and 5.0 mass % or less. An electret fiber sheet excellent in charging property and charge retention property when the fiber sheet is processed into an electret can be obtained by containing the triazine-based compound in an amount of 0.1 mass % or more, preferably 0.7 mass % or more. The charging property and the charge retention property can be exhibited at a lower cost by containing the triazine-based compound in an amount of 5.0 mass % or less, preferably 3.0 mass % or less.

In the present invention, the content of the triazine-based compound may be determined, for example, as follows, similarly to the hindered amine-based compound. The fiber sheet is subjected to Soxhlet extraction with a methanol/chloroform mixed solution, thereafter HPLC fractionation of the extract is repeated, and the structure of each fractionated substance is checked by IR measurement, GC measurement, GC/MS measurement, MALDI-MS measurement, ¹H-NMR measurement, and ¹³C-NMR measurement. The sum of the masses of the fractionated substances containing the triazine-based compound is obtained, the proportion thereof with respect to the entire fiber sheet is determined, and this proportion is regarded as the content of the triazine-based compound.

The triazine-based compound used in the present invention is a compound having a triazine ring structure represented by the following General Formula (2).

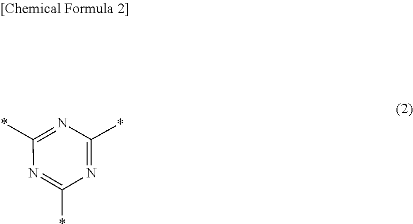

In General Formula (2), * represents a bond.

Examples of the triazine-based compound having this triazine ring structure include poly[(6-(1,1,3,3-tetramethylbutyl)imino-1,3,5-triazine-2,4-diyl) ((2,2,6,6-tetramethyl-4-piperidyl)imino)hexamethylene((2,2,6,6-tetramethyl-4-piperidyl)imino)](“Chimassorb” (registered trademark) 944LD manufactured by BASF Japan Ltd.), a polycondensate of dibutylamine, 1,3,5-triazine, N,N′-bis(2,2,6,6-tetramethyl-4-piperidyl-1,6-hexamethylenediamine, and N-(2,2,6,6-tetramethyl-4-piperidyl)butylamine (“Chimassorb” (registered trademark) 2020 manufactured by BASF Japan Ltd.), and 2-(4,6-diphenyl-1,3,5-triazine-2-yl) ((hexyl)oxy)-phenol (“Tinuvin” (registered trademark) 1577ED manufactured by BASF Japan Ltd.).

Among these hindered amine-based compounds and the triazine-based compounds, it is more preferable to use a compound having both the structures of General Formulae (1) and (2) because the amount of the compound to be added into the fiber sheet can be reduced and the charging property and the charge retention property can be exhibited at a low cost. Examples of such a compound include poly[(6-(1,1,3,3-tetramethylbutyl)imino-1,3,5-triazine-2,4-diyl) ((2,2,6,6-tetramethyl-4-piperidyl)imino)hexamethylene((2,2,6,6-tetramethyl-4-piperidyl)imino)](“Chimassorb” (registered trademark) 944LD manufactured by BASF Japan Ltd.) and a polycondensate of dibutylamine, 1,3,5-triazine, N,N′-bis(2,2,6,6-tetramethyl-4-piperidyl-1,6-hexamethylenediamine, and N-(2,2,6,6-tetramethyl-4-piperidyl)butylamine (“Chimassorb” (registered trademark) 2020 manufactured by BASF Japan Ltd.).

[Electret Fiber Sheet]

The electret fiber sheet of the present invention preferably has a basis weight of 3 g/m² or more and 100 g/m² or less. The dust collection efficiency of the electret fiber sheet can be improved by setting the basis weight of the electret fiber sheet to 3 g/m² or more, more preferably 5 g/m² or more, and still more preferably 10 g/m² or more. Crushing of pleated peaks when pleating molding is performed on the electret fiber sheet as a filter unit can be inhibited by setting the basis weight to 100 g/m² or less, more preferably 70 g/m² or less, and still more preferably 50 g/m² or less.

The basis weight of the electret fiber sheet in the present invention is determined by taking a sample of 15 cm (length)×15 cm (width) from the electret fiber sheet, converting a value obtained by measuring the mass of the sample into a value per 1 m², and rounding the value off to the first decimal place to calculate the basis weight (g/m²) of the fiber sheet.

Another aspect of the electret fiber sheet of the present invention is an electret fiber sheet including a polyolefin-based resin fiber, wherein the electret fiber sheet has a meso pentad fraction of 85 mol % or more and 95 mol % or less, and the electret fiber sheet contains 0.1 mass % or more and 5.0 mass % or less of a hindered amine-based compound.

In another aspect of the electret fiber sheet of the present invention, it is possible to improve charging property and to obtain high dust collection efficiency by setting the meso pentad fraction of the electret fiber sheet to 85 mol % or more and 95 mol % or less, more preferably 87 mol % or more and 93 mol % or less, and still more preferably 89 mol or more and 91 mol % or less.

The meso pentad fraction of the electret fiber sheet may be analyzed by ¹³C-NMR measurement as described above. A detailed method will be described later.

In another aspect of the electret fiber sheet of the present invention, the meso pentad fraction of the electret fiber sheet may be set to 85 mol % or more and 95 mol % or less by compositing the polyolefin-based resin fiber by a polyolefin-based resin composition containing a high crystalline polyolefin resin and a low crystalline polyolefin resin and setting the proportion of mass of the low crystalline polyolefin resin in the polyolefin-based resin composition to 0.5 mass % or more and 10 mass % or less with respect to the total mass of the high crystalline polyolefin-based resin and the low crystalline polyolefin resin.

The electret fiber sheet according to embodiments of the present invention achieves both high dust collection efficiency and low pressure loss by having the above configuration. The QF value (Pa⁻¹) is an index of the dust collection performance. The QF value indicates a relation between the dust collection efficiency and the pressure loss as expressed by the following formula, and a higher QF value indicates that the dust collection efficiency is higher and the pressure loss is lower. The electret fiber sheet of the present invention preferably has a QF value of 0.12 Pa⁻¹ or more.

QF value(Pa⁻¹)=−[ln(1−(dust collection efficiency (%))/100)]/(pressure loss(Pa))

The dust collection efficiency and the pressure loss of the electret fiber sheet in the present invention are values measured and calculated by the following procedures.
(1) A measurement sample M of 15 cm (length)×15 cm (width) is collected at each of five points in the width direction of the fiber sheet (five measurement samples in total).
(2) A dust collection efficiency measuring device illustrated in the schematic side view of the FIGURE is prepared. The dust collection efficiency measuring device includes a sample holder 1 in which the measurement sample M is to be placed, a dust storage box 2 connected to an upstream side of the sample holder, and a flow meter 3, a flow control valve 4, and a blower 5 connected to a downstream side of the sample holder. The sample holder 1 is equipped with a particle counter 6, with which the number of dust particles can be measured at each of the upstream and downstream sides of the measurement sample M through a switching cock 7.
(3) A 10% aqueous solution of polystyrene particles (for example, “OptiBind, Model No.: 9100079710290” manufactured by Thermo Scientific Inc.) is diluted to 200 times with distilled water and then filled in the dust storage box 2.
(4) The measurement sample M is placed to the sample holder 1, and the air volume is adjusted by the flow control valve 4 to have a filter passing speed of 4.5 m/min, and the dust concentration is stabilized in a range of 10,000 to 40,000 pieces/2.83×10⁻⁴ m³ (0.01 ft³).
(5) The number D of dust particles at the upstream side and the number d of dust particles at the downstream side of the measurement sample M are measured three times per one measurement sample by the particle counter 6 (for example, “KC-01D” manufactured by RION Co., Ltd.), and the dust collection efficiency (%) of 0.3 to 0.5-μm particles is determined using the following calculation formula based on “Form, size and performance testing methods of filtration media for collecting airborne particulate matters” of JIS K0901:1991.

Dust collection efficiency (%)=[1−(d/D)]×100 (In the formula, d is the total number of downstream dust of three measurements and D is the total number of upstream dust of three measurements.)
(6) The pressure loss (Pa) of the measurement sample M is determined by reading the static pressure difference between the upstream side and the downstream side of the measurement sample M with a pressure gauge 8 along with the measurement of the dust collection efficiency.
(7) An average value of the dust collection efficiency (%) of five measurement samples M is calculated, and a value obtained by rounding off the average value to the fourth decimal place is regarded as the dust collection efficiency (%) of the electret fiber sheet.
(8) An average value of the pressure loss (Pa) of five measurement samples M is calculated, and a value obtained by rounding off the average value to the second decimal place is regarded as the pressure loss (Pa) of the electret fiber sheet.

[Method for Producing Electret Fiber Sheet]

Next, a method for producing the electret fiber sheet according to embodiments of the present invention will be described.

(1) Preparation of Resin Composition

For the preparation of the polyolefin-based resin composition constituting the electret fiber sheet according to embodiments of the present invention, a method of mixing a high crystalline polyolefin resin, a low crystalline polyolefin resin, and a hindered amine-based compound at a time, a method of mixing a high crystalline polyolefin resin and a polyolefin-based resin composition A described later, or the like may be used.

Examples of the method of mixing a high crystalline polyolefin resin, a low crystalline polyolefin resin, and a hindered amine-based compound at a time include a method of extruding a mixture of a high crystalline polyolefin resin, a low crystalline polyolefin resin, and a hindered amine-based compound by using a twin-screw extruder or the like such that the proportion of mass of the low crystalline polyolefin resin in the polyolefin-based resin composition is 0.5 mass % or more and 10 mass % or less with respect to the total mass of the high crystalline polyolefin-based resin and the low crystalline polyolefin resin.

Examples of the method of mixing a high crystalline polyolefin resin and the polyolefin-based resin composition A include a method of forming a chip blend by using a master batch and then extruding the chip blend. This is a method for preparing a polyolefin-based resin composition by preparing a master batch of the polyolefin-based resin composition A obtained by kneading a hindered amine-based compound into a mixture of specified amounts of a high crystalline polyolefin resin and a low crystalline polyolefin resin, chip blending the high crystalline polyolefin resin with the master batch to adjust the content to 0.5 mass % or more and 10 mass % or less with respect to the total mass of the high crystalline polyolefin-based resin and the low crystalline polyolefin resin, and kneading the blended material in an extruder.

(2) Formation of Fiber Sheet

Subsequently, a fiber sheet is formed from the obtained polyolefin-based resin composition. The method for producing the fiber sheet is not limited to a specific method, and examples thereof include a melt blown method, a spunbonding method, and an electrospinning method. Among these methods, the melt blown method is preferably used from the viewpoint that polyolefin-based resin fibers having an average single fiber diameter of 0.1 μm or more and 8.0 μm or less, the average single fiber diameter being suitable for improving the strength and the dust collection efficiency of the electret fiber sheet, can be easily spun and produced without requiring complicated steps.

The melt blown method is a method for forming a fiber sheet by forming a thread while discharging a polyolefin-based resin composition from a melt blow nozzle having a predetermined hole diameter, injecting hot air from a certain angle to the discharge part to reduce the diameter of the thread, and allowing the thread to accumulate in a collection part.

(3) Electret Process

Further, the obtained fiber sheet is processed into an electret. Examples of the method for electretizing the fiber sheet according to embodiments of the present invention include a method of continuously electretizing the fiber sheet by applying a high pressure with a non-contact application electrode while moving a ground electrode and the fiber sheet together in a state where the fiber sheet is in contact with the ground electrode, a method of electretizing the fiber sheet by spraying water jet streams or water droplet streams to the fiber sheet at a pressure sufficient for water to permeate inside the fiber sheet, and uniformly mixing positive and negative charges, and a method (hydrocharge method) of passing the fiber sheet on a slit-shaped nozzle and sucking water with the nozzle to allow water to permeate the fiber sheet, and uniformly mixing positive and negative charges.

[Stacked Sheet, Filter]

The electret fiber sheet according to embodiments of the present invention having the properties as described above can be suitably used as a stacked sheet containing at least one layer of the electret fiber sheet. An air filter medium including the electret fiber sheet or the stacked sheet of the present invention is one of preferable aspects because the high dust collection efficiency can be particularly utilized.

Examples of a method for obtaining an air filter medium from the electret fiber sheet according to embodiments of the present invention include a method of bonding the electret fiber sheet with an aggregate sheet having higher rigidity than the electret fiber sheet by spraying a moisture-curable urethane resin or the like by a spraying method, and a method of bonding the electret fiber sheet with such an aggregate sheet through a heat path by spraying a thermoplastic resin or a heat-fusible fiber.

This aggregate sheet is for collecting relatively large dust and being bonded to the electret fiber sheet to obtain rigidity required as a filter medium. As the aggregate sheet, for example, a nonwoven fabric, a woven or knitted fabric, or the like including polyester fibers, polypropylene fibers, rayon fibers, glass fibers, natural pulp, or the like may be used.

The filter medium may be used as a filter unit by being incorporated in a sheet form into a frame. The filter medium may be used as a pleated filter unit set on a frame by repeatedly folding the filter medium into pleats.

For these reasons, the air filter of the present invention preferably includes the electret fiber sheet described above. More preferably, the air filter is an air conditioning filter, an air purifier filter, or an automobile cabin filter. That is, the electret fiber sheet of the present invention can be suitably used for these filters for high-performance applications.

### EXAMPLES

Next, the present invention will be described in detail based on Examples. The present invention is not limited only to these Examples. Unless otherwise described, physical properties are measured based on the methods described above.

[Measurement Methods]

(1) Melting point of polyolefin resin:

The measurement was performed with a differential scanning calorimeter (DSC). A DSC curve was obtained while the temperature was raised from 20° C. at a rate of 20° C./min to a temperature at which an endothermic peak due to melting appeared.

(2) Basis Weight of Electret Fiber Sheet:

The measurement was performed according to the method described above.

(3) Average Single Fiber Diameter of Polyolefin-Based Resin Fiber:

The measurement was performed using “VHX-D500” manufactured by KEYENCE CORPORATION as a scanning electron microscope.

(4) Meso Pentad Fraction of Electret Fiber Sheet:

A sample of each electret fiber sheet was weighed in 63 mg and heated and dissolved at 135° C. in a solvent of 0.75 mL of o-dichlorobenzene (ODCB)-d4. This sample solution was used for NMR measurement. The meso pentad fraction of each sample was calculated from the peak area value obtained from the NMR measurement result. The ¹³C NMR measurement conditions are as follows.
¹³C NMR measurement conditions
Device used: ECZ-600R (manufactured by JEOL RESONANCE Inc.)
Probe: SuperCOOL open type probe
Measurement method: single 13C pulse with 1H decoupling
Observation nucleus: 13C
Observation frequency: 150.9 MHz
Pulse width: 6.20 s
Lock solvent: ODCB-d4
Chemical shift reference: ODCB-d4 (The peak observed on the lowest magnetic field side was set to 133 ppm.)
Observation width: about 37,900 Hz
Number of data points: 32,768
Waiting time: 10 seconds
Number of integrations: 2,048 times
Measurement temperature: 135° C.
Sample rotation speed: 15 Hz

(5) Dust Collection Efficiency, Pressure Loss, and QF Value of Electret Fiber Sheet:

“OptiBind, Model No.: 9100079710290” manufactured by Thermo Scientific Inc. was used as a 10% aqueous solution of polystyrene particles. “KC-01D” manufactured by RION Co., Ltd. was used as a particle counter of the dust collection efficiency measuring device.

(6) Dust Collection Efficiency Change Rate Before and After Heat Treatment (Evaluation of Thermal Stability):

The electret fiber sheet was cut into 15 cm (length)×15 cm (width). Each sample was subjected to heat treatment for 5 minutes while being suspended in a hot air dryer (“TABAI PHH −100” manufactured by ESPEC Corp.) set at 130° C. The dust collection efficiency of the heat-treated sample was measured by the method (4) described above, and the average value of the five measurement samples was calculated using the following calculation formula to calculate the dust collection efficiency change rate before and after the heat treatment.

Dust collection efficiency change rate (%)=(dust collection efficiency after heat treatment−dust collection efficiency before heat treatment)/dust collection efficiency before heat treatment×100

[Polyolefin-Based Resin Composition]

The resins and compounds used as raw materials of the polyolefin-based resin composition in Examples 1 to 8 and Comparative Examples 1 to 7 are as follows.
High crystalline polyolefin resin: polypropylene (MFR: 1,100 g/10 min)
Low crystalline polyolefin resin A: “L-MODU” (registered trademark) 5400 (MFR: 2,600 g/10 min) manufactured by Idemitsu Kosan Co., Ltd.
Low crystalline polyolefin resin B: “L-MODU” (registered trademark) 5600 (MFR: 390 g/10 min) manufactured by Idemitsu Kosan Co., Ltd.
Hindered amine-based compound: “Chimassorb” (registered trademark) 944LD (described as “Chimassorb944” in Tables 1 to 3) manufactured by BASF Japan Ltd.

### Example 1

The high crystalline polyolefin resin and the low crystalline polyolefin resin A were mixed at a mass ratio of high crystalline polyolefin resin:low crystalline polyolefin resin A=99:1, and 1 mass % of the hindered amine-based compound was added, whereby a chip blend was obtained. Next, this chip blend was charged into a raw material hopper of an extruder and supplied to a gear pump while being melted and kneaded by the extruder. The polyolefin-based resin composition weighed in the gear pump was injected by a melt blown method using a spinneret in which discharge holes having a diameter of 0.4 mm were arranged in a straight line, under the conditions of a discharge amount of 23.6 g/min, a nozzle temperature of 260° C., and an air pressure of 0.07 MPa, and a collection conveyor speed was adjusted to obtain a fiber sheet having a basis weight of 20 g/m². Subsequently, the obtained fiber sheet was processed into an electret, whereby an electret fiber sheet was obtained.

The obtained electret fiber sheet is shown in Table 1.

### Example 2

An electret fiber sheet was obtained in the same manner as in Example 1 except that the mixing mass ratio of the high crystalline polyolefin resin and the low crystalline polyolefin resin A was changed to high crystalline polyolefin resin:low crystalline polyolefin resin A=97:3.

The obtained electret fiber sheet is shown in Table 1.

### Example 3

An electret fiber sheet was obtained in the same manner as in Example 1 except that the mixing mass ratio of the high crystalline polyolefin resin and the low crystalline polyolefin resin A was changed to high crystalline polyolefin resin:low crystalline polyolefin resin A=99.5:0.5.

The obtained electret fiber sheet is shown in Table 1.

### Example 4

An electret fiber sheet was obtained in the same manner as in Example 1 except that the mixing mass ratio of the high crystalline polyolefin resin and the low crystalline polyolefin resin A was changed to high crystalline polyolefin resin:low crystalline polyolefin resin A=95:5.

The obtained electret fiber sheet is shown in Table 1.

### Example 5

An electret fiber sheet was obtained in the same manner as in Example 1 except that the mixing mass ratio of the high crystalline polyolefin resin and the low crystalline polyolefin resin A was changed to high crystalline polyolefin resin:low crystalline polyolefin resin A=90:10.

The obtained electret fiber sheet is shown in Table 1.

### Example 6

An electret fiber sheet was obtained in the same manner as in Example 1 except that the mixing mass ratio of the high crystalline polyolefin resin and the low crystalline polyolefin resin B was changed to high crystalline polyolefin resin:low crystalline polyolefin resin B=99:1.

The obtained electret fiber sheet is shown in Table 1.

### Example 7

The high crystalline polyolefin resin and the low crystalline polyolefin resin B were mixed at a mass ratio of high crystalline polyolefin resin:low crystalline polyolefin resin B=99:1, and 1 mass % of the hindered amine-based compound was added, whereby a chip blend was obtained. Next, this chip blend was charged into a raw material hopper of an extruder and supplied to a gear pump while being melted and kneaded by the extruder. The polyolefin-based resin composition weighed in the gear pump was injected by a melt blown method using a spinneret in which discharge holes having a diameter of 0.4 mm were arranged in a straight line, under the conditions of a discharge amount of 50.0 g/min, a nozzle temperature of 220° C., and an air pressure of 0.07 MPa, and a collection conveyor speed was adjusted to obtain a fiber sheet having a basis weight of 20 g/m². Subsequently, the obtained fiber sheet was processed into an electret, whereby an electret fiber sheet was obtained.

The obtained electret fiber sheet is shown in Table 1.

### Comparative Example 1

An electret fiber sheet was obtained in the same manner as in Example 1 except that the low crystalline polyolefin resin A was not used and the added amount of the hindered amine-based compound was changed to 0.05 mass % to obtain a polyolefin-based resin composition.

The obtained electret fiber sheet is shown in Table 2.

### Comparative Example 2

An electret fiber sheet was obtained in the same manner as in Example 1 except that the low crystalline polyolefin resin A was not used to obtain a polyolefin-based resin composition.

The obtained electret fiber sheet is shown in Table 2.

### Comparative Example 3

An electret fiber sheet was obtained in the same manner as in Example 1 except that the added amount of the hindered amine-based compound was changed to 0.05 mass % to obtain a polyolefin-based resin composition.

The obtained electret fiber sheet is shown in Table 2.

### Comparative Example 4

An electret fiber sheet was obtained in the same manner as in Example 1 except that the mixing mass ratio of the high crystalline polyolefin resin and the low crystalline polyolefin resin A was changed to high crystalline polyolefin resin:low crystalline polyolefin resin A=80:20.

The obtained electret fiber sheet is shown in Table 2.

### Comparative Example 5

An electret fiber sheet was obtained in the same manner as in Example 7 except that the low crystalline polyolefin resin B was not used to obtain a polyolefin-based resin composition.

The obtained electret fiber sheet is shown in Table 2.

TABLE 1

| Standards | | | | Example 1 | Example 2 | Example 3 | Example 4 |
|---|---|---|---|---|---|---|---|
| High crystalline | | Resin type | | Polypropylene | Polypropylene | Polypropylene | Polypropylene |
| polyolefin resin | | MFR (g/10 min) | | 1100 | 1100 | 1100 | 1100 |
| | | Melting point (° C.) | | 163 | 163 | 163 | 163 |
| Low crystalline | | Compound name | | S400 | S400 | S400 | S400 |
| polyolefin resin | | (trade name) | | | | | |
| | | MFR (g/10 min) | | 2600 | 2600 | 2600 | 2600 |
| | | Melting point (° C.) | | 80 | 80 | 80 | 80 |
| Hindered amine- | | Compound name | | chimassorb944 | chimassorb944 | chimassorb944 | chimassorb944 |
| based compound | | (trade name) | | | | | |
| | | Content (mass %) | | 1 | 1 | 1 | 1 |
| Mass ratio of high crystalline | | | | 99:1 | 97:3 | 99.5:0.5 | 95:5 |
| polyolefin resin/low crystalline | | | | | | | |
| polyolefin resin | | | | | | | |
| Production method | | | | Melt blown | Melt blown | Melt blown | Melt blown |
| Spinneret | | | | Uniform holes | Uniform holes | Uniform holes | Uniform holes |
| Physical | Before | Basis weight (g/m²) | | 20 | 20 | 20 | 20 |
| property | heat | Average single | | 1.6 | 1.6 | 1.6 | 1.6 |
| | treatment | fiber diameter (μm) | | | | | |
| | | Meso pentad | | 92.1 | 90.1 | 94.2 | 88.6 |
| | | fraction (mol %) | | | | | |
| | | Dust collection | | 99.69 | 99.76 | 99.58 | 99.47 |
| | | efficiency (%) | | | | | |
| | | Pressure loss (Pa) | | 41.1 | 40.5 | 40.9 | 39.4 |
| | | QF value (Pa⁻¹) | | 0.14 | 0.15 | 0.13 | 0.13 |
| | After heat | Dust collection | | 97.11 | 97.34 | 95.79 | 96.45 |
| | treatment | efficiency (%) | | | | | |
| | Dust collection efficiency | | | −2.6 | −2.4 | −3.8 | −3.0 |
| | change rate before and after | | | | | | |
| | heat treatment (%) | | | | | | |
| | | Standards | | | Example 5 | Example 6 | Example 7 |
| | | High crystalline | | Resin type | Polypropylene | Polypropylene | Polypropylene |
| | | polyolefin resin | | MFR (g/10 min) | 1100 | 1100 | 1100 |
| | | | | Melting point (° C.) | 163 | 163 | 163 |
| | | Low crystalline | | Compound name | S400 | S600 | S600 |
| | | polyolefin resin | | (trade name) | | | |
| | | | | MFR (g/10 min) | 2600 | 390 | 390 |
| | | | | Melting point (° C.) | 80 | 80 | 80 |
| | | Hindered amine- | | Compound name | chimassorb944 | chimassorb944 | chimassorb944 |
| | | based compound | | (trade name) | | | |
| | | | | Content (mass %) | 1 | 1 | 1 |
| | | Mass ratio of high crystalline | | | 90:10 | 99:1 | 99:1 |
| | | polyolefin resin/low crystalline | | | | | |
| | | polyolefin resin | | | | | |
| | | Production method | | | Melt blown | Melt blown | Melt blown |
| | | Spinneret | | | Uniform holes | Uniform holes | Uniform holes |
| | | Physical | Before | Basis weight (g/m²) | 20 | 20 | 20 |
| | | property | heat | Average single | 1.6 | 1.6 | 5.1 |
| | | | treatment | fiber diameter (μm) | | | |
| | | | | Meso pentad | 85.6 | 91.2 | 90.8 |
| | | | | fraction (mol %) | | | |
| | | | | Dust collection | 99.31 | 99.75 | 96.53 |
| | | | | efficiency (%) | | | |
| | | | | Pressure loss (Pa) | 41.8 | 38.8 | 23.2 |
| | | | | QF value (Pa⁻¹) | 0.12 | 0.15 | 0.14 |
| | | | After heat | Dust collection | 95.68 | 97.55 | 94.22 |
| | | | treatment | efficiency (%) | | | |

| | | | |
|---|---|---|---|
| Dust collection efficiency | −3.7 | −2.2 | −2.4 |
| change rate before and after | | | |
| heat treatment (%) | | | |

TABLE 2

| | | | Comparative | Comparative | Comparative | Comparative | Comparative |
|---|---|---|---|---|---|---|---|
| Standards | | | Example 1 | Example 2 | Example 3 | Example 4 | Example 5 |
| High crystalline | | Resin type | Polypropylene | Polypropylene | Polypropylene | Polypropylene | Polypropylene |
| polyolefin resin | | MFR (g/10 min) | 1100 | 1100 | 1100 | 1100 | 1100 |
| | | Melting point (° C.) | 163 | 163 | 163 | 163 | 163 |
| Low crystalline | | Compound name (trade name) | — | — | S400 | S400 | — |
| polyolefin resin | | MFR (g/10 min) | — | — | 2600 | 2600 | — |
| | | Melting point (° C.) | — | — | 80 | 80 | — |
| Hindered amine- | | Compound name (trade name) | chimassorb944 | chimassorb944 | chimassorb944 | chimassorb944 | chimassorb944 |
| based compound | | Content (mass %) | 0.05 | 1 | 0.05 | 1 | 1 |
| Mass ratio of high crystalline polyolefin resin/low | | | — | — | 99:1 | 80:20 | — |
| crystalline polyolefin resin | | | | | | | |
| Production method | | | Melt blown | Melt blown | Melt blown | Melt blown | Melt blown |
| Spinneret | | | Uniform holes | Uniform holes | Uniform holes | Uniform holes | Uniform holes |
| Physical | Before heat | Basis weight (g/m²) | 20 | 20 | 20 | 20 | 20 |
| property | treatment | Average single fiber | 1.6 | 1.6 | 1.6 | 1.6 | 5.1 |
| | | diameter (μm) | | | | | |
| | | Meso pentad fraction (mol %) | 97.9 | 98.2 | 90.2 | 80.1 | 98.2 |
| | | Dust collection efficiency | 94.03 | 97.11 | 94.13 | 96.01 | 92.84 |
| | | (%) | | | | | |
| | | Pressure loss (Pa) | 45.8 | 42.4 | 43.9 | 46.2 | 26.5 |
| | | QF value (Pa⁻¹) | 0.06 | 0.08 | 0.06 | 0.07 | 0.10 |
| | After heat | Dust collection efficiency | 88.56 | 91.65 | 91.16 | 86.32 | 87.94 |
| | treatment | (%) | | | | | |

| | | | | | |
|---|---|---|---|---|---|
| Dust collection efficiency | −5.8 | −5.6 | −3.2 | −10.1 | −5.3 |
| change rate before and after | | | | | |
| heat treatment (%) | | | | | |

### Example 8

As a polyolefin-based resin component A, the high crystalline polyolefin resin and the low crystalline polyolefin resin A were mixed at a mass ratio of high crystalline polyolefin resin:low crystalline polyolefin resin A=99:1, and 1 mass % of the hindered amine-based compound was added, whereby a chip blend was obtained. As a polyolefin-based resin component B, a chip blend was obtained in the same manner as in the case of the polyolefin-based resin component A. Then, by using two extruders, two gear pumps, and a melt blow spinneret for mixed fiber spinning having two types of discharge holes a and b (hole diameter of a: 0.25 mm, hole diameter of b: 0.6 mm, hole number of a: 95 holes, hole number of b: 20 holes, spinneret width: 150 mm, a-a hole pitch: 1 mm, a-b hole pitch: 2 mm, hole arrangement: five of the hole a are inserted between two of the hole b and arranged in a line), the component A and the component B were respectively guided to the holes a and the holes b of the melt blow spinneret for mixed fiber spinning at a mass ratio of component A:component B=60:40, and injected at single-hole discharge rates of 0.28 g/min/hole and 0.90 g/min/hole, respectively, by a melt blown method under the conditions of a nozzle temperature of 280° C. and an air pressure of 0.06 MPa, and a collecting conveyor speed was adjusted to obtain a fiber sheet having a basis weight of 20 g/m². Subsequently, the obtained fiber sheet was processed into an electret, whereby an electret fiber sheet was obtained.

The obtained electret fiber sheet is shown in Table 3.

### Comparative Example 6

An electret fiber sheet was obtained in the same manner as in Example 8 except that the low crystalline polyolefin resin A was not used to obtain the polyolefin-based resin component B.

The obtained electret fiber sheet is shown in Table 3.

### Comparative Example 7

An electret fiber sheet was obtained in the same manner as in Example 8 except that the high crystalline polyolefin resin was not used to obtain the polyolefin-based resin component A, and the low crystalline polyolefin resin A was not used to obtain the polyolefin-based resin component B.

The obtained electret fiber sheet is shown in Table 3.

TABLE 3

| | | | | Comparative | Comparative |
|---|---|---|---|---|---|
| Standards | | | Example 8 | Example 6 | Example 7 |
| Component | High | Resin type | Polypropylene | Polypropylene | — |
| A | crystalline | MFR (g/10 min) | 1100 | 1100 | — |
| | polyolefin | Melting point (° C.) | 163 | 163 | — |
| | resin | | | | |
| | Low | Compound name | S400 | S400 | S400 |
| | crystalline | (trade name) | | | |
| | polyolefin | MFR (g/10 min) | 2600 | 2600 | 2600 |
| | resin | Melting point (° C.) | 80 | 80 | 80 |
| | Hindered | Compound name | chimassorb944 | chimassorb944 | chimassorb944 |
| | amine-based | (trade name) | | | |
| | compound | Content (mass %) | 1 | 1 | 1 |
| | Mass ratio of high crystalline | | 99:1 | 99:1 | — |
| | polyolefin resin/low crystalline | | | | |
| | polyolefin resin | | | | |
| Component | High | Resin type | Polypropylene | Polypropylene | Polypropylene |
| B | crystalline | MFR (g/10 min) | 1100 | 1100 | 1100 |
| | polyolefin | Melting point (° C.) | 163 | 163 | 163 |
| | resin | | | | |
| | Low | Compound name | S400 | — | — |
| | crystalline | (trade name) | | | |
| | polyolefin | MFR (g/10 min) | 2600 | — | — |
| | resin | Melting point (° C.) | 80 | — | — |
| | Hindered | Compound name | chimassorb944 | chimassorb944 | chimassorb944 |
| | amine-based | (trade name) | | | |
| | compound | Content (mass %) | 1 | 1 | 1 |
| | Mass ratio of high crystalline | | 99:1 | — | — |
| | polyolefin resin/low crystalline | | | | |
| | polyolefin resin | | | | |
| Mass ratio of component A/component B | | | 60:40 | 60:40 | 60:40 |
| Production method | | | Melt blown | Melt blown | Melt blown |
| Spinneret | | | Mixed fiber | Mixed fiber | Mixed fiber |
| Physical | Before heat | Basis weight | 20 | 20 | 20 |
| property | treatment | (g/m²) | | | |
| | | Average single | 1.7 | 1.7 | 1.7 |
| | | fiber diameter (μm) | | | |
| | | Meso pentad | 90.3 | 95.4 | 98.0 |
| | | fraction (mol %) | | | |
| | | Dust collection | 99.45 | 97.66 | 99.09 |
| | | efficiency (%) | | | |
| | | Pressure loss (Pa) | 35.3 | 36.1 | 52.1 |
| | | QF value (Pa⁻¹) | 0.15 | 0.10 | 0.09 |
| | After heat | Dust collection | 96.69 | 92.98 | 10.39 |
| | treatment | efficiency (%) | | | |

| | | | |
|---|---|---|---|
| Dust collection efficiency | −2.8 | −4.8 | −89.5 |
| change rate before and after | | | |
| heat treatment (%) | | | |

As is apparent from Tables 1 to 3, the electret fiber sheets described in Examples 1 to 8 of the present invention achieved high dust collection efficiency while having a low pressure loss, which shows that the electret fiber sheets are excellent in dust collection performance and electret thermal stability.

In contrast, the electret fiber sheet described in Comparative Example 1 having only a component not containing the specified amounts of the low crystalline polyolefin resin and the hindered amine-based compound had a low dust collection efficiency and was poor in electret thermal stability as compared with the electret fiber sheets described in Examples 1 to 6.

The electret fiber sheet described in Comparative Example 2 having only a component not containing the low crystalline polyolefin resin had a low dust collection efficiency and was poor in electret thermal stability as compared with the electret fiber sheets described in Examples 1 to 6.

The electret fiber sheet according to Comparative Example 3 having only a component not containing the specified amount of the hindered amine-based compound had a low dust collection efficiency as compared with the electret fiber sheets according to Examples 1 to 6.

The electret fiber sheet described in Comparative Example 4 having only a component not containing the specified amount of the low crystalline polyolefin resin had a low dust collection efficiency and was poor in electret thermal stability as compared with the electret fiber sheets described in Examples 1 to 6.

The electret fiber sheet described in Comparative Example 5 having only a component not containing the low crystalline polyolefin resin had a low dust collection efficiency and was poor in electret thermal stability as compared with the electret fiber sheet described in Example 7.

The electret fiber sheet described in Comparative Example 6 in which a part of the fiber constituent raw material of the polyolefin-based resin fibers constituting the electret fiber sheet was only the high crystalline polyolefin resin had a low dust collection efficiency as compared with the electret fiber sheet described in Example 8.

The electret fiber sheet described in Comparative Example 7 in which the fiber constituent raw material was only the high crystalline polyolefin resin or the low crystalline polyolefin resin had a low dust collection efficiency and was poor in electret thermal stability as compared with the electret fiber sheet described in Example 8.

As seen above, according to embodiments of the present invention, an electret fiber sheet having higher dust collection performance than ever before and is excellent in electret thermal stability at a high temperature can be obtained by adding a low crystalline polyolefin resin to reduce the degree of crystallinity and expand an amorphous region. The electret fiber sheet can be suitably used for filter media and all kinds of air filters, in particular, high-performance applications of air conditioning filters, air purifier filters, and automobile cabin filters.

### DESCRIPTION OF REFERENCE SIGNS

1: Sample holder
2: Dust storage box
3: Flow meter
4: Flow control valve
5: Blower
6: Particle counter
7: Switching cock
8: Pressure gauge
M: Measurement sample

1. An electret fiber sheet comprising a polyolefin-based resin fiber composed of a polyolefin-based resin composition containing a high crystalline polyolefin resin and a low crystalline polyolefin resin,
wherein the low crystalline polyolefin resin in the polyolefin-based resin composition has a proportion of mass of 0.5 mass % or more and 10 mass % or less with respect to a total mass of the high crystalline polyolefin-based resin and the low crystalline polyolefin resin, and the electret fiber sheet contains a hindered amine-based compound in an amount of 0.1 mass % or more and 5.0 mass % or less.

2. The electret fiber sheet according to claim 1, wherein the electret fiber sheet has a QF value of 0.12 Pa⁻¹ or more.

3. The electret fiber sheet according to claim 1, wherein the electret fiber sheet has an average single fiber diameter of 0.1 μm or more and 8.0 μm or less.

4. An electret fiber sheet comprising a polyolefin-based resin fiber,
wherein the electret fiber sheet has a meso pentad fraction (mmmm) of 85 mol % or more and 95 mol % or less, and the electret fiber sheet contains a hindered amine-based compound in an amount of 0.1 mass % or more and 5.0 mass % or less.

5. A stacked sheet comprising at least one layer of the electret fiber sheet according to claim 1.

6. A filter comprising the electret fiber sheet according to claim 1.
